(19) United States
(12) Patent Application Publication
(10) Pub. No.: US 2013/0039488 A1
(43) Pub. Date: Feb. 14, 2013

(54) Device and method for providing portable and secure internet-based IT services

(71) Applicants: Simon Keith Smith, Bicester (GB); Clifford Jack Milliner, Bicester (GB)

(72) Inventors: Simon Keith Smith, Bicester (GB); Clifford Jack Milliner, Bicester (GB)

(21) Appl. No.: 13/207,408

(22) Filed: Aug. 10, 2011

(51) Int. Cl. H04L 9/00; G06F 7/00

(52) U.S. Cl. 380/44; 707/610; 707/E17.005

(57) ABSTRACT

The increase in popularity of Internet-based computing services for delivery of their information technology (IT) capability has also created dependences for the user to access their IT facilities and be able to work. The current invention provides solutions to these dependences using a system with a convenient, highly portable data storage device that when connected to a general purpose computer that has access to the internet, provides the user the ability to access and work on large, complex tasks and files on their internet-based IT facilities while simultaneously maintaining the security and integrity of the information and data transmitted over the internet between the user and their IT facilities.

### BACKGROUND OF THE INVENTION

There has been a substantial increase in popularity of companies or individuals using Internet-based computing services for delivery of their information technology (IT) capability. This increase in the use of Internet-based IT services has also created dependences for the user to access their IT facilities and be able to work.

One critical dependence for using Internet-based IT services is the requirement of a constant connection to the Internet to access the service provider's server infrastructure. If the user cannot maintain a connection to the Internet, or a connection is not available, the user will be unable access their IT facilities and will be unable to work.

Another dependency is the need for integrity and security in all the information and data sent between the user and their IT facilities over the Internet. The integrity and security dependency has many aspects to it, for example the need for strong authentication requirements of the user in order to prevent unauthorized access of the IT facilities over the Internet.

Another aspect of the need for integrity and security is the device that is used to send and receive information and data over the internet. Normally the device is a general purpose computer such as a desktop or laptop, but the lack of portability of a desktop and the security risks associated with laptops during transit from one location to another make neither device ideal or convenient for secure Internet based IT services for users in remote locations.

The introduction of smartphones and tablet-based computing devices with internet capabilities has also driven demand for Internet-based IT services due to their size and convenience, but the physical size and computing capabilities of these devices make them less suitable than laptops and desktop computers for working on large or complex tasks and for supporting the additional computing requirements needed for encryption and other security measures.

Accordingly there is the need for a device to provide solutions to the limitations of Internet-based IT services as described above.

### BRIEF SUMMARY OF INVENTION

The current invention is a system that uses a convenient, highly portable data storage device that when connected to a general purpose computer that has access to the Internet, provides the user the ability to access and work on large, complex tasks and files on their internet-based IT facilities while simultaneously maintaining the security and integrity of the information and data transmitted over the internet between the user and their IT facilities.

The current invention further enables users to continue to work on data and files even if the user is unable to connect to the Internet by using portable applications and data secured within a secure virtual environment created by the system. The file data held on the corporate file system and on the file data on the highly portable device being synchronised at a later time when an internet connection becomes available.

### BRIEF DESCRIPTION OF THE DRAWINGS

FIG. 1 is a schematic diagram showing the components of, and connections between, the Secure Data Storage Device, the Host Computer, and a Service Provider as used in an embodiment of the current invention.

### DETAILED DESCRIPTION OF INVENTION

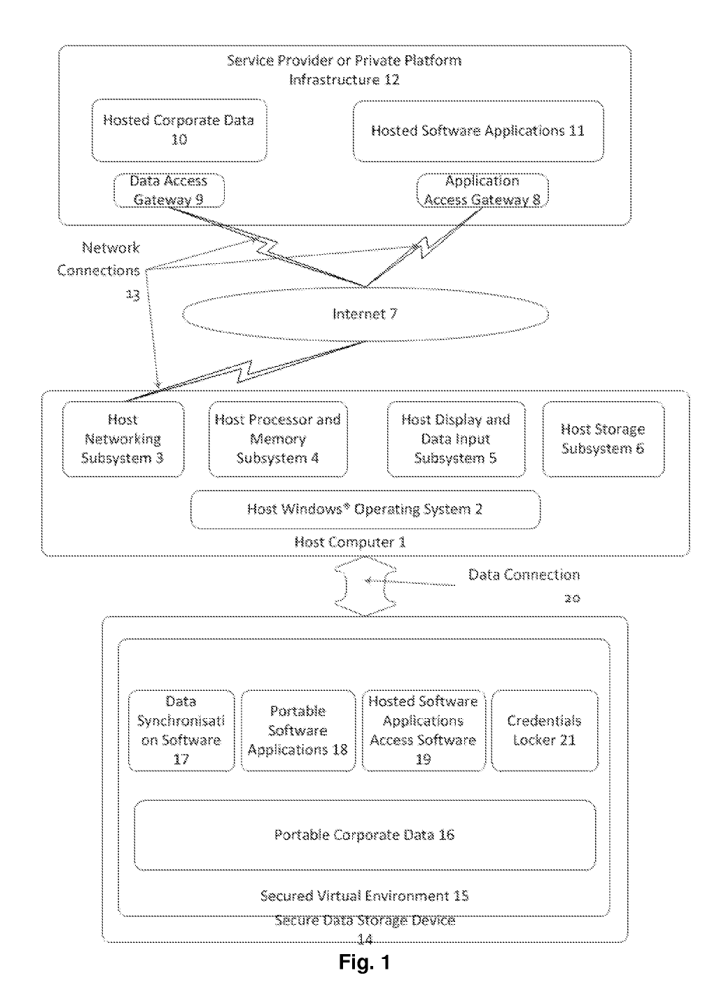

As shown in FIG. 1, an embodiment of the current invention uses a Secure Data Storage Device 14, a Host Computer 1 and a Service Provider 12; with the Secure Data Storage Device 14 and Host Computer 1 connected by a Data Connection 20, and the Host Computer 1 and Service Provider 12, connected by Network Connections 13 over the Internet 7. The following is a detailed description of the components and connections of this embodiment of the current invention:

The Host Computer 1 is a general purpose computer having a Host Networking Subsystem 3, a Host Processor and Memory Subsystem 4, a Host Display and Data Input Subsystem 5, a Host Storage subsystem 6 and is capable of running a Host Operating System 2.

The Host Operating System 2 is software used by the Host Computer 1 to manage the resources of the Host Computer 1 to provide services for execution of application software. In an embodiment of the current invention as shown in FIG. 1, the Host Operating System 2 is a “WINDOWS XP®” computer operating software from Microsoft Corporation of Redmond, Washington.

Host Networking Subsystem 3 provides the network access capability to the Internet 7, from the Host Operating System 2. In the embodiment of the current invention in FIG. 1 it is assumed that the Host Operating System 2 is able to utilise the Host Networking Subsystem 3 to access the Internet 7.

The Host Processor and Memory Subsystem 4 provide the Host Computer 1 with necessary central processing unit (CPU) and memory storage systems needed in order to operate the Host Operating System 2.

Host Display and Data Input Subsystem 5 displays the dialogs from the Host Operating System 2 and allows interaction via the input subsystem using any suitable input device such as a keyboard, mouse, touch screen input etc.

Host Storage Subsystem 6 provides data storage capacity for the Host Operating System 2.

The Internet 7 is the worldwide, publicly accessible network of interconnected computer network that connects computers around the world via the TCP/IP protocol.

The Application Access Gateway 8 provides the ability to access Hosted Software Applications 11 by securely connecting over the Internet 7 from any computer. Hosted Software Applications 11 can only be accessed from the Internet 7 via the Application Access Gateway 8, on presentation of authorized credentials. Access to, and the use of hosted applications always takes place over a secure encrypted channel. In an embodiment of the current invention as shown in FIG. 1, the Application Access Gateway 8 is “NETSCALER®” version 9.2 from Citrix Systems, Inc. of Fort Lauderdale, Fla.

The Data Access Gateway 9 provides the ability to access the hosted data by using the WebDAV protocol, which is secured by public key encryption over the internet on port 443 from any computer. Accordingly in the embodiment of the current invention shown in FIG. 1 the Data Access Gateway 9 is a WebDAV-enabled Web server, but other systems can perform the same function, such as a system using the Secure FTP protocol. The Hosted Corporate Data 10 can only be accessed from the internet via the Data Access Gateway 9, on presentation of authorized credentials with all data transfers taking place over an encrypted channel secured by Public Key encryption.

The Hosted Corporate Data 10 is file data that is at rest on the Service Provider or Private platform infrastructure 12, and accessible over the Internet 7 via the Data Access Gateway 9.

The Hosted Software Applications are software application programs on Service Provider or Private platform infrastructure 12, and accessible over the Internet 7 via Application Access Gateway 8.

The Service Provider or Private platform infrastructure 12 are one or many general purpose computers in an IT infrastructure, commonly known as a service provider computers, that provide software and/or data services to users over the Internet 7.

The Network connections 13 are connections between Internet 7, Application Access Gateway 8, Data Access Gateway 9 and Host Networking Subsystem 3. All network connections 13 are authenticated by the Service Provider or Private Platform Infrastructure 12 and is secured using a encryption system and encryption key. In an embodiment of the current invention the Service Provider or Private Platform Infrastructure 12 uses the Public Key encryption system for encrypting and decrypting data transmitted over the network connections 13 and stored on the Secure Data Storage Device 14.

The Secure Data Storage Device 14 is a highly portable data storage device that uses always on hardware encryption to ensure that all data stored on the device is constantly encrypted. In the embodiment of the invention the Secure Data Storage Device 14 is based on the IronKey Enterprise USB key from IronKey, Inc. of Sunnyvale, Calif. Access to the encrypted data is only granted on presentation of authorized credentials, which will be authorised by an IronKey Enterprise service provider computer, or if no connection to the Internet 7 is available will allow local authentication to the Secure Data Storage Device 14 for predetermined period of time. A further feature of this embodiment of the current invention is that the encrypted data on Secure Data Storage Device 14 can only be accessed presentation of authorized credentials.

The Secured Virtual Environment 15 is the workspace virtualization software stored on the Secure Data Storage Device 14 that creates a virtual application environment by isolating applications from the Host Operating System 2. The workspace virtualisation software also prevents a user copying application program files out of the Secured Virtual Environment 15.

The workspace virtualisation software enables selected applications to be run without having to be installed on the Host Computer 1 and without leaving file data within the Host Operating System 2. The virtualised applications are also locked to the Secured Data Storage Device 14 using a device ID, preventing the applications being run or accessed from any other device.

The workspace virtualisation software also allows locally-installed applications to be run and to access file data in either Host Storage Subsystem 6 or Portable Corporate Data 16 but will not allow the user to save the file data to any location other than Portable Corporate Data 16.

The workspace virtualisation software conducts endpoint analysis of the Host Computer 1 to determine whether the Host Computer 1 has conflicting software applications running locally. If this is the case, the workspace virtualisation software will offer the user the option to close the locally installed application.

The workspace virtualisation software also determines whether Host Computer 1 has valid, updated anti-virus software installed and running. The workspace virtualisation software can be configured to either warn the user, or not to launch, if the anti-virus software on the Host Computer 1 is not valid. In an embodiment of the current invention the Secured Virtual Environment 15 is Ceedo Enterprise software version 4.6.1.17 from Ceedo Technologies (2005) Ltd. of Rosh Haayin, Israel.

The Portable Corporate Data 16 is file data that is contained in the Secured Virtual Environment 15, and encrypted at rest by the Secure Storage Device 14. The Portable Corporate Data 16 can be synchronised with the Hosted Corporate Data 10. Unencrypted Portable Corporate Data 16 can not be copied off the Secure Storage Device 14 from within the Secured Virtual Environment 15.

The Data Synchronization Software 17 is data synchronization software that provides automatic, secure bi-directional synchronization of Portable Corporate Data 16 and Hosted Corporate Data 10 from the Secure Data Storage Device 14 over the Internet 7 in a secure encrypted channel. The Data Synchronisation Software 17 checks the Host Networking Subsystem 3 to determine whether a Network Connection 13 to the Internet 7 is available. If a Network Connection 13 is available, the Data Synchronisation Software 17 will automatically conduct bi-directional data synchronisation. The user can configure the frequency of automatic synchronisation from within the Data Synchronisation Software 17.

The Portable Software Applications 18 are software application programs stored on the Secure Storage Device 14 that can be run in the Secured Virtual Environment 15.

The Hosted Application Access Software 19 is client software that enables the user to access and run Hosted Software Applications 11 from any Host Computer 1. In an embodiment of the current invention Hosted Application Access Software 19 is Citrix Online Client version 12.0 from the Citrix Systems, Inc. of Fort Lauderdale, Fla.

The Data Connection 20 provide data connectivity between the Secure Data Storage Device 14 and the Host Computer 1. In an embodiment of the current invention Data Connection 20 is through a USB port connection, but the Data Connection 20 could be use alternative physical, wireless or optical data connection systems or protocols such as a Bluetooth, wireless, Wi-Fi, or optical connections.

The Credentials Locker 21 is an encrypted database stored in the Secured Virtual Environment 15 that contains usernames, passwords and other authentication data that can be dynamically inserted into Portable Software Applications 18 if they require authentication to external services. The Credentials Locker 21 negates the need for the user to use the Host Display and Data Input Subsystem 5 to enter user credentials into Portable Software Applications 18 that require authentication. The use of the Credentials Locker 2 also prevents any malware installed on a Host Computer 1, such as keylogging software, from capturing the user credentials.

The following describes how to build in an embodiment of the current invention using the components and connections as described above:
a. Connect the Secure Data Storage Device 14 to Host Computer 1 via the Data Connection 20.
b. The Host Operating System 2 will load the Secure Data Storage Device 14.
c. Using Host Display and Data Input Subsystem 5, unlock the Secure Data Storage Device 14.
d. Install the Secured Virtual Environment 15 workspace virtualisation software onto the Secure Data Storage Device 14.
e. Run the Secured Virtual Environment 15 software.
f. Activate the Secured Virtual Environment 15 software.
g. Using the Secured Virtual Environment 15 workspace virtualisation software, install the following required software applications into the Secured Virtual Environment 15
   i. Hosted Software Application Access Software 19, and configure the URL of the Application Access Gateway 8
   ii. Data Synchronisation Software 17. Configure a network path to the Remote Corporate Data 16 and the Data Access Gateway 9 and set a synchronisation schedule in the Data Synchronisation Software 17.
   iii. Credentials Locker 21 software.
h. Install and configure any required Portable Business Software Applications 18. To run required Portable Business Applications, additional software may need to be installed. For example, for Microsoft Corporation's “OUTLOOK” software program to run in the Secured Virtual Environment 15, the following software will need to be installed:
   i. Microsoft® .net framework x86 and x64 versions:
      a. V1.1.4322
      b. V2.0.50727
      c. V3.0
      d. V3.5
      e. V4.0.30319
   ii. Microsoft® C++ redistributable x86 and X64 versions:
      a. 2005
      b. 2008
      c. 2010
i. To create a more functional portable workspace, the following software applications can be installed.
   i. Install Java runtime environment Version 6
   ii. Install Adobe® Acrobat Reader® Version 10.0
   iii. Install Mozilla® Firefox® version 5
   iv. Install Adobe® Flash® for Microsoft® Internet Explorer® and Firefox
j. Close the Secured Virtual Environment 15.
k. Lock the Secure Data Storage Device 14 and disconnect from the Host Computer 1.

When built, the current invention is intended to provide the following principal capabilities to a user:
a. Synchronise Hosted Corporate Data 10.
The ability to synchronise Hosted Corporate Data 10 to become Portable Corporate Data 16 using the Data Synchronisation Software 17 to enable the user to access and manipulate any of the Portable Data 16 with the Portable Software Applications 18;
b. Use Portable Software Applications 18.
The ability to use the Portable Software Applications 18 running from the Secured Virtual Environment 15 on any Host Computer 1 with a Host Operating System 2 with no Network Connection 13 to the Internet 7 to manipulate any of the Portable Corporate Data 16;
c. Synchronise Portable Corporate Data 16.
The ability to synchronise any Portable Corporate Data 16 that is modified or created using the Portable Software Applications 18 back to the Hosted Corporate Data 10 and vice versa; and
d. Access Hosted Software Applications 11 from any Host Computer 1.
The ability to access Hosted Software Applications 11 and Hosted Corporate Data 10 from any Host Computer 1 with a Host Operating System 2 using the Hosted Software Applications Access Software 19 in conjunction with any Host Computer 1 if the Host Networking Subsystem 3 has a network connection to the Internet 7 which allows network traffic on port 443.

When built, the current invention delivers the principal capabilities to a user identified above by using the following processes:
a. Synchronise Hosted Corporate Data 10
   i. The Data Access Gateway 9 defines the root folder in Hosted Corporate Data 10 that will synchronise with Portable Corporate Data 16. This is achieved by publishing the root folder as a secure WebDAV folder to the Internet 7.
   ii. When the Secured Virtual Environment 15 is launched by the user, it is configured to automatically run the Data Synchronisation Software 17.
   iii. If the Host Networking Subsystem 3 has a Network Connection 13 to the Internet 7, the Data Synchronisation Software 17 connects to the Hosted Corporate Data 10 via the Data Access Gateway 9 and authenticates itself using the user credentials it has been configured with.
   iv. Data change analysis is performed on the Hosted Corporate Data 10 and Portable Corporate Data 16.
   v. Bi-directional synchronisation of the changed data in each location is initiated over a secure encrypted channel from the Data Synchronisation Software 17 to the Data Access Gateway 9. When this activity is complete, the Hosted Corporate Data 10 and Portable Corporate Data 16 are synchronised.
b. Use Portable Software Applications 18
   i. The Secured Virtual Environment 15 runs on the Host Windows® Operating System 2 and displays an application toolbar.
   ii. The user selects the application they wish to use by clicking on the relevant application icon on the application toolbar. Alternatively, the user can open Windows® Explorer from the application toolbar and can navigate to the desired file. If the user double clicks the desired file, the relevant application will open from the Secured Virtual Environment 15 to edit the file.
   iii. If the Portable Software Applications 18 change or create new Portable Corporate Data 16, it can only be saved in the Secured Virtual Environment 15; it cannot be saved to the Host Storage Subsystem 6 on the Host Computer 1.
c. Synchronise Portable Corporate Data 16
   i. When the Secured Virtual Environment 15 is running (which will be the case when Portable Software Applications 18 are running) the Data Synchronisation Software 17 periodically checks via the Host Networking Subsystem 3 for a Network Connection 13 via the Internet 7 to the Data Access Gateway 9.
   ii. If a connection is available, the Data Synchronisation Software 17 performs a data change analysis on Portable Corporate Data 16 and Hosted Corporate Data 10. If data has changed in either location, a bi-directional data synchronisation is carried out by the Data Synchronisation Software
   iii. Changed data is synchronised over a secure encrypted channel from the Data Synchronisation Software 17 to the Data Access Gateway 9. Synchronising the Hosted Corporate Data 10 and Portable Corporate Data 16.
d. Access Hosted Software Applications 11 from any Host Computer 1
   i. Hosted Software Applications 11 are accessible using Hosted Software Applications Access Software via the Application Access Gateway 8
   ii. The Hosted Software Applications Access Software 19 runs from within the Secured Virtual Environment 15.
   iii. If the Host Networking Subsystem 3 has a Network Connection 13 to the Internet 7, the user can run the Hosted Software Applications Access Software 19 and it will connect to the Application Access Gateway 8.
   iv. Once the user has been authenticated using the Credentials Locker 21, the Hosted Software Applications Access Software 19 will establish a secure, encrypted channel to the Application Access Gateway 8.
   v. The user is then able to use the Hosted Software Applications 11 Hosted Software Applications Access Software 19 within the Secured Virtual Environment 15 using the Host Display and Data Input Subsystem 5 to display screen shots to the user and accept keyboard and mouse events from the user.

The current invention is not limited nor restricted by the embodiments of the current invention as disclosed herein. The current invention may be implemented by using other components, devices, software programs and methods as known by those of ordinary skill in the art. The above disclosure of the embodiments of the current invention should not be viewed as imposing limitations or restrictions on alternative implementations of the invention.

We claim:

1. A device comprising a data storage device in data connection with a general purpose computer having data access to a service provider computer, a software application program stored on either the data storage device or the service provider computer, the general purpose computer operating the software application program to alter data stored on the data storage device, and data synchronization software stored on the data storage device allowing storage of the altered data on the data storage device and the service provider computer.

2. A device as in claim 1 wherein the data access is the internet.

3. A device as in claim 1 wherein the data connection is a physical, wireless or optical data connection.

4. A device as in claim 1 wherein the data stored on the data storage device is encrypted.

5. A device as in claim 4 wherein the general purpose computer requires encryption key stored on the service provider computer to read and alter data stored on the data storage device.

6. A device as in claim 5 wherein the encryption key is generated using the Public Key encryption protocol.

7. A device as in claim 1 wherein the service provider computer is a plurality of general purpose computers.

8. A device comprising a data storage device having data, authentication data, data synchronization software, and a data connection to a general purpose computer having data access to a service provider computer, such that the authentication data enables the general purpose computer to run a software application program stored on the service provider computer, the software application program enabling the general purpose computer to alter the data stored on the data storage device, and the data synchronization software allowing storage of the altered data on the data storage device and the service provider computer.

9. A device as in claim 8 wherein the data access is the internet.

10. A device as in claim 8 wherein the data connection is a physical, wireless or optical data connection.

11. A device as in claim 8 wherein the data stored on the data storage device is encrypted.

12. A device as in claim 11 wherein the general purpose computer requires encryption key stored on the service provider computer to read and alter data stored on the data storage device.

13. A device as in claim 12 wherein the encryption key is generated using the Public Key encryption protocol.

14. A device as in claim 8 wherein the service provider computer is a plurality of general purpose computers.

15. A method comprising
connecting a data storage device to a general purpose computer;
accessing data from a service provider computer to the general purpose computer,
storing a software application program on either the data storage device or the service provider computer,
operating the software application program on the general purpose computer,
altering data stored on the data storage device with the software application program, and
synchronizing the altered data on the data storage device with the data stored the service provider computer by using synchronization software stored on data storage device and operated on the general purpose computer.

16. A method as in claim 15 wherein the accessing data is the internet.

17. A method as in claim 15 wherein connecting is a physical, wireless or optical data connection.

18. A method as in claim 15 wherein the general purpose computer requires encryption key stored on the service provider computer to read and alter data stored on the data storage device.

19. A method as in claim 18 wherein the encryption key is generated using the Public Key encryption protocol.

20. A method as in claim 15 wherein the service provider computer is a plurality of general purpose computers.
